(19) United States
(12) Patent Application Publication
(10) Pub. No.: US 2015/0034020 A1
(43) Pub. Date: Feb. 5, 2015

(54) Animal Restraint System for a Moving Vehicle

(71) Applicant: Richard H. Santos, Fort Myers, FL (US)

(72) Inventor: Richard H. Santos, Fort Myers, FL (US)

(21) Appl. No.: 13/959,072

(22) Filed: Aug. 5, 2013

(51) Int. Cl. A01K 1/02; A44B 11/04; A01K 27/00; A44B 11/00; B60R 22/10

(52) U.S. Cl. CPC A01K 1/0263; A44B 11/006; B60R 22/10; A01K 27/002; A44B 11/04
USPC 119/771; 24/164; 29/525.01

(57) ABSTRACT

A buckle assembly 1 comprising a flat planar member 2 having a first pair of slots 3 and a second pair of slots 4 for securing and restraining an object to a belt system on a moving vehicle during transit, said first pair of slots 3 is adapted to receive an adjustable strap 6 and said second pair of slots 4 are adapted to receive a belt system on a motor vehicle, said adjustable strap 6 having a proximal end connected to said first pair of slots 3 and a distal end connected to an object using a swivel hook 8.

### CROSS REFERENCE TO RELATED APPLICATIONS

None

### FEDERALLY SPONSORED RESEARCH

None

### SEQUENCE LISTING

None

### BACKGROUND OF THE INVENTION

1. Field of the Invention

This invention relates generally to a safety restrainer for use in a vehicle for securing a pet and more particularly pertains to a pet safety for controllably restraining a pet during collision or sudden braking when travelling in the vehicle having a belt system therein.

2. Description of the Related Prior Art

Traveling in a vehicle with a dog can pose a serious danger to the pet. Should another passenger collide with a pet, serious injuries can result to all occupants concerned. Even worse the pet could be thrown from the vehicle in a collision. For pet safety during travel in a vehicle, use of a variety of pet containers or harnesses types and designs is know in the prior art. Several of these pet containers or harnesses comprise familiar, expected and obvious structural configurations, notwithstanding the myriad of designs encompassed by the many of such pet containers or harnesses which have been devised to fulfill numerous objectives and requirements associated with pet travel in a vehicle.

In addition to the danger posed by an accident, a restraint system which allows free movement of the animal when restrained can cause a distraction to the driver of the motor vehicle as the pet could try to sit on the drivers' lap or other distracting actions.

U.S. Pat. No. 6,834,621 (2004) to O'Neill shows the state of the art wherein a dog is restrained in a moving automobile by a tethering device which is connected directly into an existing seat belt clasp. This design allows the animal excessive freedom of movement which can cause a distraction to the driver of the motor vehicle if the animal were to encroach on the drivers' space.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later in this application.

The present invention is directed to overcoming or at least reducing the problems set forth above.

In the preferred embodiment of the present invention, a buckle assembly is attached to an existing seat belt in a motor vehicle by a first and second pair of slots, one pair for attaching the buckle assembly to the existing seat belt of the motor vehicle and the other pair connected to adjustable strap. The adjustable strap would be attached to a harness positioned on the animal in a manner which would cause minimal injury thereto during an accident.

The advantages of the invention will become apparent from the study of the following description and the accompanying drawings. It should be understood that variations may be made in the details and general features of the design concept without departing from the spirit and scope of the invention. For example, the use of the present invention is not limited to use in an automobile or pick-up truck. The use of the present invention could be used in any moving vehicle including a boat, a ship, a barge, a train, a plane, a bus, a helicopter, golf cart or any other mode of transportation. The present invention could be used to secure and restrain any object which is transported by any one of the above modes. In addition to transporting an animal, this invention could be used for securing a baby seat or any package needing restraint during travel.

In addition to the structure defined in specification and claims the applicant has also devised a method for fastening a buckle assembly to an existing safety belt in an automobile. By sliding a seat belt through the edge opening of the second pair of slots it has been found to be a more secure means of attachment.

### BRIEF DESCRIPTION OF THE DRAWINGS

FIG. 1 is plan view of the flat planar member of the buckle assembly.

FIG. 2 is a view of the planar member attached to the seat belt of a vehicle.

FIG. 3 is a schematic view of a dog being restrained in a car seat by the buckle assembly of the present invention.

FIG. 4 is a schematic view of the buckle assembly restraining a plurality of animals in the bed of a pick-up truck.

### DETAILED DESCRIPTION OF THE DRAWINGS

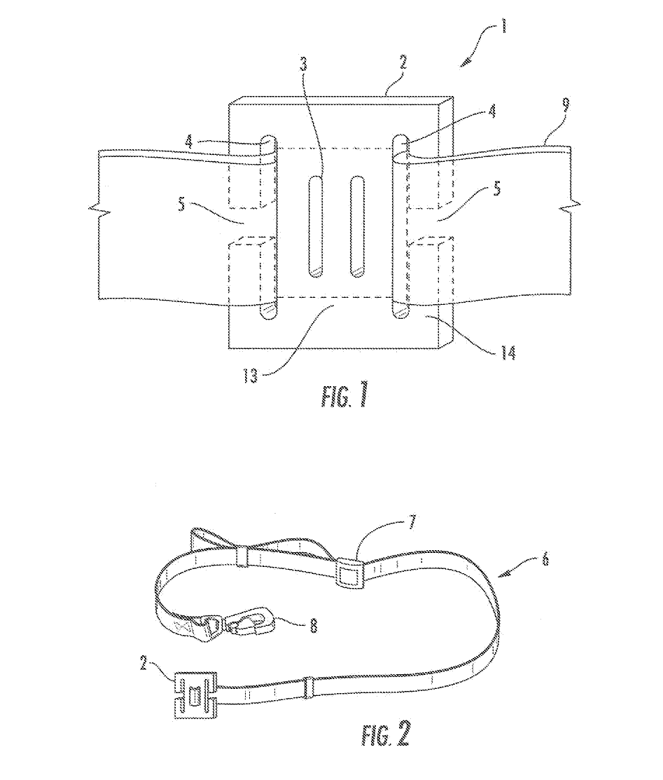

FIG. 1 is a schematic view of the buckle assembly 1 attached to the seat belt 9 of a moving automobile wherein an animal is properly restrained on the seat by use of the buckle assembly 1 of the present invention. In the preferred embodiment the buckle assembly 1 comprises a flat planar member 2 having a first pair of slots 3 located at a central portion 13 therein and structurally accepts an adjustable strap 6 at its proximal end and is adapted to be fastened at its distal end to a harness comfortably positioned on the animal so that any forces transmitted to the animal would be minimal. Such a harness is of the non choker type and is well known in the prior art and can be purchased at any pet store. A second pair of slots 4 are positioned on the outer sides 14 of the central portion 13 of the flat planar member 2, one on each side thereof. Each slot in the second pair of slots 4 has an edge opening 5 to accept a seat belt 9 to pass therethrough and thereby securely fasten the flat planar member 2 to the seat belt 9 of the moving automobile. The flat planar member 2 can be made manufactured from any metal capable of withstanding a tensile force of up to 400 pounds or more. For example, the flat planar member could be made from chrome plated steel, aluminum, brass, carbon fiber or any synthetic material which would meet the specifications. The surface of the flat planar member can be polished to provide a smooth surface and rounded edges. The flat planar member 2 can be of any geometric shape; e.g. square, rectangular, oval or circular as long as the inherent tensile strength is not compromised. The adjustable strap 6 is structurally connected to the flat planar member 2 by passage through the first pair of slots 3. A cam buckle 7 is provided thereto to adjust the length of the strap. Its distal end has a swivel hook 8 for fastening to the ring on the animal harness.

FIG. 2 is a view the flat planar member 2 attached to the seat belt 9 in an automobile.

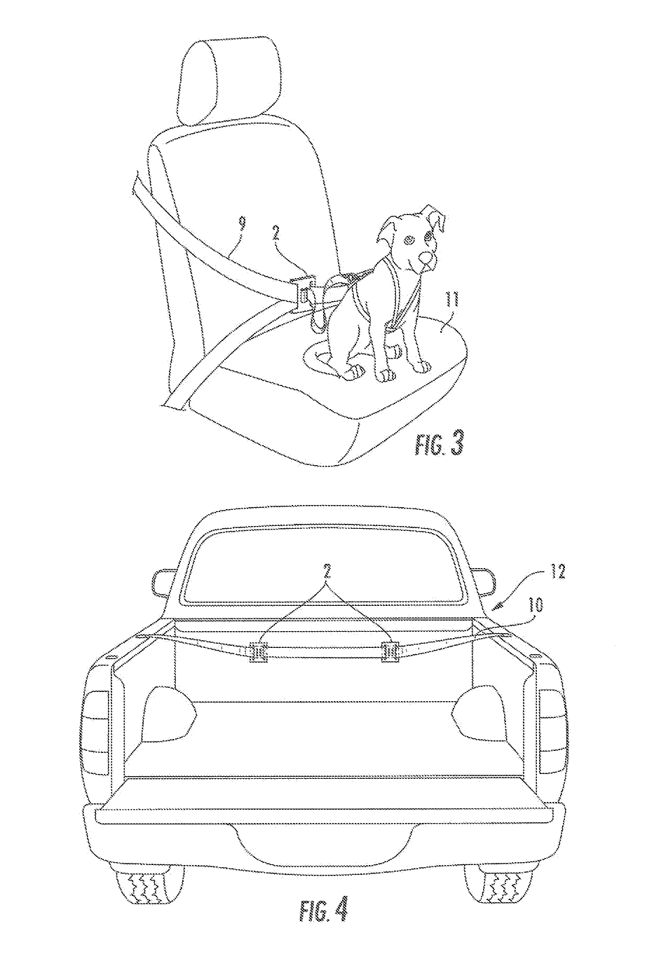

FIG. 3 is an overall view of the invention to be used on the seat of an automobile and the flat planar member is secured to the safety belt 9 securing and restraining an animal.

FIG. 4 is an overall view of the invention being used on a pick-up truck wherein a transverse belt system 10 is positioned across the bed of the pick-up wherein a plurality of buckle assemblies 1 could be used for transportation of more than one animal.

### NUMERALS

1. Buckle assembly
2. Flat planar member
3. First pair of slots
4. Second pair of slots
5. Edge openings
6. Adjustable strap
7. Cam buckle
8. Swivel hook
9. Seat belt
10. Transverse belt
11. Automobile seat
12. Pick-up truck
13. Central portion
14. Outer sides

### OPERATION

The buckle assembly of the present invention is used with the seat belt 9 in a passenger vehicle or a transverse belt 10 across the bed of a pickup truck 12 for securing an object or a plurality of objects depending upon the needs of the transporter. The flat planar member 2 has a first pair of slots 3 which accept an adjustable strap 6 at its proximal end and a means on the object being restrained at its distal end. The second pair of slots 4 has edge openings 5. The animal to be restrained is placed on the seat of an automobile. The flat planar member 2 having the adjustable strap 6 attached thereon by the first pair of slots 3 is orientated so that the edge of the belt slides into the edge opening 5 of one slot of the second pair of slots 4 and then orientated so that the belt passes through the edge opening of the other of said second pair of slots 4 thereby securing the flat planar member 2 to the seat belt 9. The adjustable strap 6 is secured to the animal such that very little movement of the object occurs during transport.

When transporting an animal in the back of a pick-up truck 12 a transverse belt 10 can be easily fastened across the bed of the pick-up truck and fastened to side openings on the frame of the pick-up truck. Such frame openings are well known in the art and are not considered part of the instant invention. A plurality of buckle assemblies 1 can be used at the same time to secure a plurality of animals in much the same way as set forth above.

The buckle assembly 1 of the present invention is connected securely to the belt system of the moving vehicle by locating the object to be restrained and secured in close proximity to the belt system. The buckle assembly 1 already has the adjustable strap 6 connected to the first pair of slots. The belt system is pinched in such a way that it easily slides into the edge opening 5 of one of the slots of said second pair of slots 4. The belt system is slid behind the buckle assembly 1 and in similar manner the belt system is pinched to facilitate its entry into the edge opening 5 of the other slot of the second pair of slots 4. The buckle assembly 1 is now securely fastened to the belt system. The object is now fastened to the adjustable strap such that the object is securely restrained from movement.

1: A buckle assembly adapted to secure an object to a seat belt on a moving vehicle comprising: a flat planar member having a geometric shape and having a first and second pair of slots therein, said first pair of slots adapted for receiving an adjustable strap, said second pair of slots having edge openings adapted for receiving a seat belt.

2: the buckle assembly as set forth in claim 1, wherein said adjustable strap has a proximal end and a distal end, and wherein the proximal end thereof passes through the first pair of slots and the distal end has means for connection to an object.

3: the buckle assembly as set forth in claim 2, wherein said adjustable strap comprises a swivel hook at its distal end for fastening said strap to a receiving means on said object and means for fastening said strap at its proximal end to said first pair of slots and a cam buckle positioned therebetween for adjusting the length of said adjustable strap.

4: the buckle assembly as set forth in claim 3, wherein the geometric shape is a member of the group consisting of a square, a rectangle, an oval, a circle or any other geometric shape having the size and shape capable of accepting a seat belt and for securing an object.

5: the buckle assembly as set forth in claim 3, wherein said moving vehicle is a member of the group consisting of a car, pick-up truck, semi, minivan, boat, ship, barge, train, subway, airplane, helicopter, golf cart or any device of transporting an object.

6: the buckle assembly as set forth in claim 3, wherein said flat planar member is constructed from a material which is a member of the group consisting of chrome plated steel, aluminum, brass, carbon fiber or any other material capable of withstanding a force up to at least 400 lbs or more.

7: a buckle assembly for restraining and securing an object on in a moving vehicle when connected to a belt system comprising: a flat planar member having a geometric shape and including a central portion and having outer sections on either side thereof, said central portion including a first pair of slots adapted to receive an adjustable strap, a second pair of slots adapted to receive a belt system, said second pair of slots including one slot or either side of said central portion, each slot of said second pair of slots having an edge opening to facilitate the ingress and egress of a belt system, said adjustable strap including a proximal portion attached to the first pair of slots and a distal portion including a swivel hook adapted to be fastened to a harness on an object being transported.

8: the buckle assembly as set forth in claim 7, wherein the geometric shape is a member of the group consisting of a square, a rectangle, an oval, a circle or any other geometric shape having the size and shape for accepting a seat belt.

9: the buckle assembly as set forth in claim 7, wherein the moving vehicle is a member of the group consisting of a car, pick-up truck, semi, minivan, boat, ship, barge, train, subway, airplane, helicopter, golf cart or any device of transporting an object.

10: the buckle assembly as set forth in claim 7, wherein the flat planar member is made of a material which is a member of the group consisting of chrome plated steel, aluminum, brass, carbon fiber or any material capable of withstanding a force up to 400 lbs or more.

11: the buckle assembly as set forth in claim 7: wherein the moving vehicle is a pick-up truck having a bed and said belt system is positioned transverse to said bed and connected to the sides of the pick-up truck and a plurality of flat planar members are connected to the belt system for transport of more than one object.

12: the method of fastening an object to a belt system on a moving vehicle using the buckle assembly as forth in claim 7 comprising:
positioning the object in proximity to said belt system on said moving vehicle,
pinching said belt system in a manner which can easily slide into one of said second pair of slots through the edge opening therein,
passing the belt system behind the flat planar member and pinching the belt system in a manner which can easily slide into the other slot of said second pair of slots through its edge opening thereby securing said buckle assembly to the belt system,
securing the adjustable strap to said harness on said object.

13: the method as set forth in claim 12, wherein said belt system is a seat belt in a moving vehicle and the object is positioned on a seat thereof.

14: the method as set forth in claim 12, wherein said belt system is a transverse belt positioned on a pick-up truck and a plurality of objects are secured to the belt system.

15: the method as set forth in claim 12, wherein the object is a dog.
